(19) United States
(12) Patent Application Publication
(10) Pub. No.: US 2018/0025704 A1
(43) Pub. Date: Jan. 25, 2018

(54) COMPOSITE USER INTERFACE

(71) Applicant: TEKTRONIX, INC., BEAVERTON, OR (US)

(72) Inventor: LAKSHMANAN GOPISHANKAR, PORTLAND, OR (US)

(21) Appl. No.: 15/388,801

(22) Filed: Dec. 22, 2016

Related U.S. Application Data
(60) Provisional application No. 62/365,290, filed on Jul. 21, 2016.

(51) Int. Cl. G09G 5/377; G06T 1/20; G06T 11/00; G09G 5/397

(52) U.S. Cl. CPC G09G 5/377; G09G 5/397; G06T 1/20; G06T 11/001; G09G 2340/125; G06F 17/2247

(57) ABSTRACT

A system for displaying information including a central processing unit, the central processing unit receiving real-time image data consisting of at least one of waveform and picture data, and web input data and producing a first graphics layer of web data, a second graphics layer of graticule data, and a third graphics layer of real-time data, a memory connected to the central processing unit to store the first, second and third graphics layers, a graphics processor to retrieve the first, second and third graphics layers from the memory and to generate a display window, and a display device to display the display window.

### RELATED APPLICATIONS

This application claims priority to U.S. Provisional Application 62/365,290, filed Jul. 21, 2016, which is incorporated by reference in its entirety.

### TECHNICAL FIELD

This disclosure relates to video monitoring instruments and, more particularly, to video monitoring instruments that produce a composite user interface.

### BACKGROUND

Video monitoring instruments present real-time data, such as rasterized waveforms and picture displays on a user interface or user monitor. These instruments include oscilloscopes and other waveform generating equipment. Text data, such as video session and status data may also be displayed. The typical approach to creating user interfaces for such instruments involves creating custom menus using low level software. Although products in the gaming industry can combine some Javascript/HTML components, such as player scores, with generated data, such as a game landscape, there is no known method for combining real time data, like waveforms and picture displays, with Javascript/HTML components.

Embodiments discussed below address limitations of the present systems.

### BRIEF DESCRIPTION OF THE DRAWINGS

FIG. 1 shows an embodiment of a video processing system.

FIG. 2 shows a flowchart of an embodiment of a method of combining various components of image data into an image.

FIG. 3 shows an embodiment of a system of processing video using an array of texture array processors.

FIG. 4 shows a flowchart of an embodiment of a method of processing video frames.

### DETAILED DESCRIPTION

Modern desktop processors typically have on board GPUs that provide the opportunity to accelerate computation and rendering without the need to have expensive add-on GPU cards. Such on board GPUs can be used to create a user interface that combines real-time waveforms and picture data combined with Javascript/HTML based user interface data.

In addition, GPUs provide an excellent way to implement different video processing techniques, like frame rate conversions. 2D texture arrays are an excellent way to implement a circular buffer inside the GPU, which can hold picture frames, allowing for implementation of various frame rate conversion algorithms. Embodiments disclosed here follow a segmented approach where work is divided between a CPU and one or more GPUs, while using the 2D texture array of the GPU as a circular buffer. It is also possible to use a circular buffer outside of the GPU, if the GPU used does not provide one.

HTML and Javascript based user interfaces are modern and flexible, but unfortunately do not provide an easy way to get access to acquisition data that make up the rasterized waveforms and picture data. Embedding tools such as Awesomium and Chromium Embedded Framework (CEF) provide a way to overlay Javascript/HTML components over user generated textures. Textures may be thought of as images represented in the GPU—for example, a landscape scene in a video game.

Embodiments here create a simple, flexible and scalable way of overlaying Javascript/HTML components over rasterized waveforms and picture data to create a user interface that is Javascript/HTML powered, and which also provides “windows” in the Javascript layer through which real time data may be acquired and processed before presenting the composite user interface to the user.

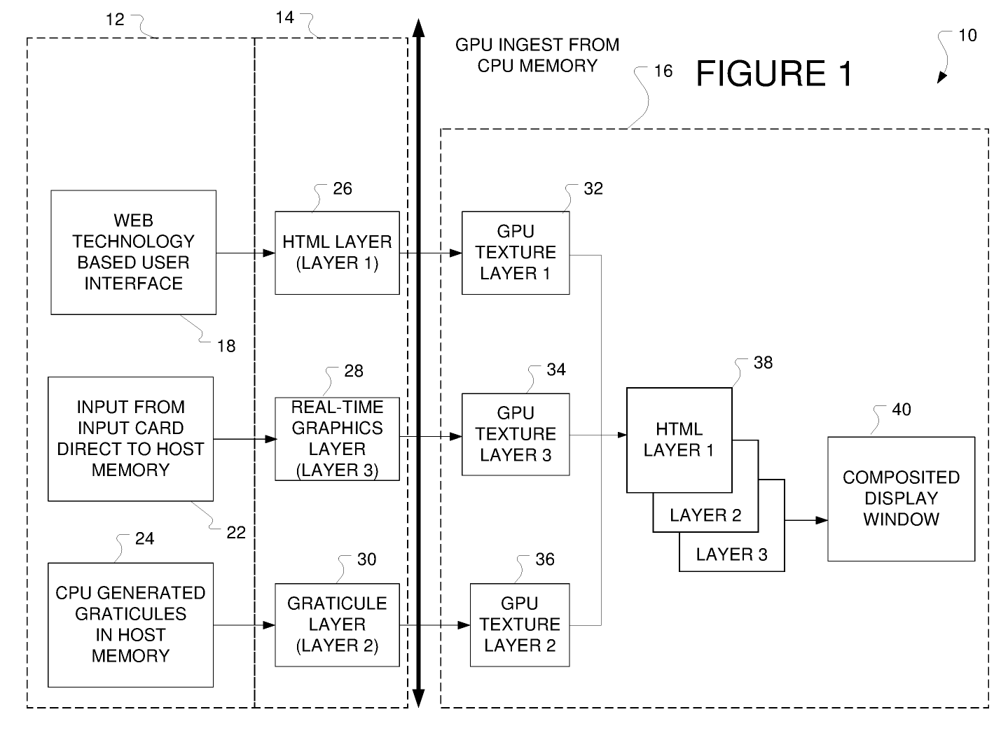

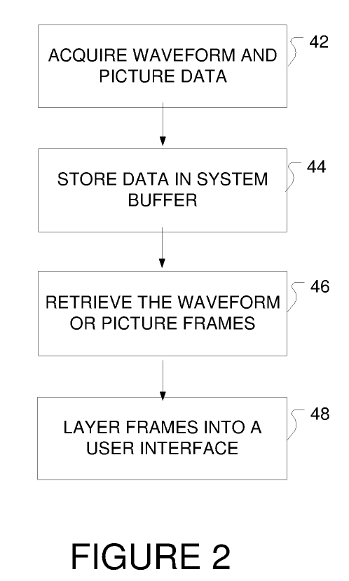

As shown in FIGS. 1 and 2, an application 22 acquires real-time image data, consisting of at least one of waveform and picture data by, for example, a custom PCIe based card and transported over a PCIe bus into a large ring buffer in the system memory 14. This ring buffer is set up in shared memory mode so that another, external, application can retrieve the waveform, or picture, frames, one frame at a time and upload them into GPU memory as textures. A ‘texture’ in this discussion is a grip or mapping of surfaces used in graphics processing to create images. This external application then uses the GPU to layer them in the appropriate order to achieve the look of a user interface.

A web technology based user interface 18 allows creation of typical user interface image components like menus and buttons, which would eventually be overlaid onto the waveform and picture. The user interface is rendered into “off-screen” space in system memory 14.

The memory 14 may consist of the system memory used by the CPU and has the capability of being set up as a shared memory, as discussed above. This avoids the need to copy waveform and picture data before ingest by the GPU. However, the embodiments here provide only one example of a memory architecture, and no limitation to a particular embodiment is intended nor should it be implied.

A separate application 24 also generates graticules, also called grats, which are simply a network of lines on the monitoring equipment's display. For example, on the display for an oscilloscope the graticules may consist of axes of one measure over another, with the associated divisions. These will be added as the third layer to the elements used in the display.

The GPU 16 accesses the memory and processes the individual layers 32, 34 and 36 to generate the image shown at 38. The image 38, has the HTML layer with the menu information on ‘top’ as seen by the user, followed by the graticules for the display and then the real-time waveform data that may be a trace from an oscilloscope or other testing equipment and/or picture data behind that. This composite image is then generated into a display window 40.

FIG. 2 shows a flowchart of one embodiment of this process. The CPU acquires waveform and picture data at 42 as discussed above and stores the data in the system buffer at 44. The GPU then retrieves the waveform or picture frames 46, and then layers them into the user interface 48. Within this system, many options consist for the processing.

For example, depending on the frame rate of the input video signal, the frame rate of the picture data can be any rates such as 23.97, 30, 50, 59.94 or 60 Hz. The frames may also be progressive or interlaced. The display rate of the monitor used to display the user interface is fixed, for example, at 60 Hz, but may also be adjustable to other rates. This means that the picture data stream may need to be frame rate converted before being composited by the GPU for the display.

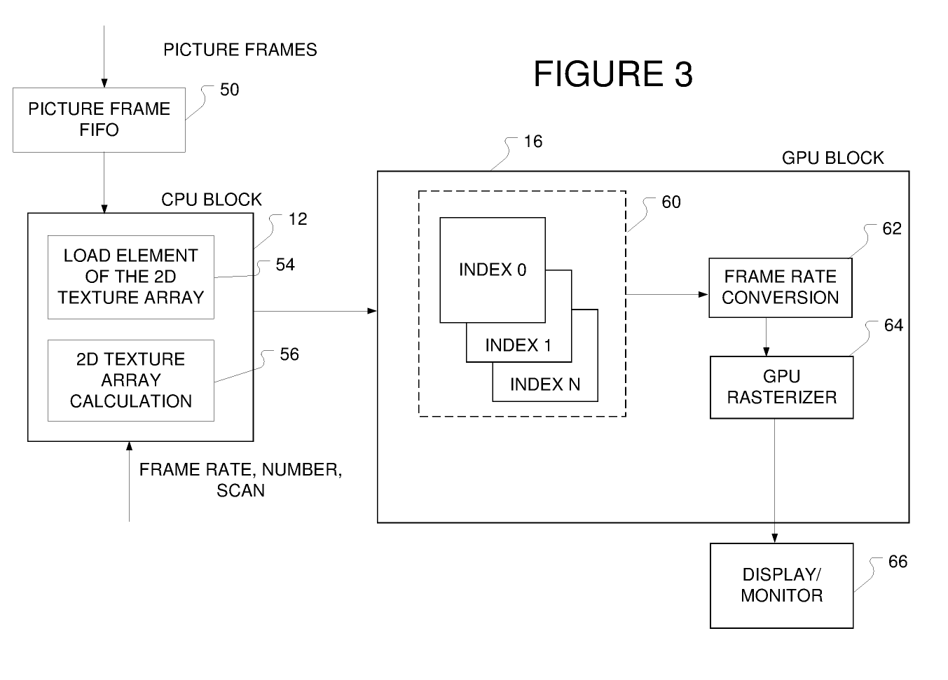

FIG. 3 illustrates an example embodiment of splitting the frame rate conversion work using both a CPU and one or more GPUs. As illustrated in FIG. 3, input signals to the CPU processing block 12 include a frame data signal, which may contain at least one of the input video frame rate, the display frame number, scan type, in addition to the actual picture frame data. The frame rate signal allows the system to determine whether the frame data is interlaced or progressive. The picture frame data is represented inside the GPU in terms of a texture unit loaded by the CPU at 54. The embodiments here for the GPU also provide a way to use an array of texture units 56, each element of which can be updated independently. The 2D texture array feature of the GPUs are used to build up a small circular buffer of picture frames.

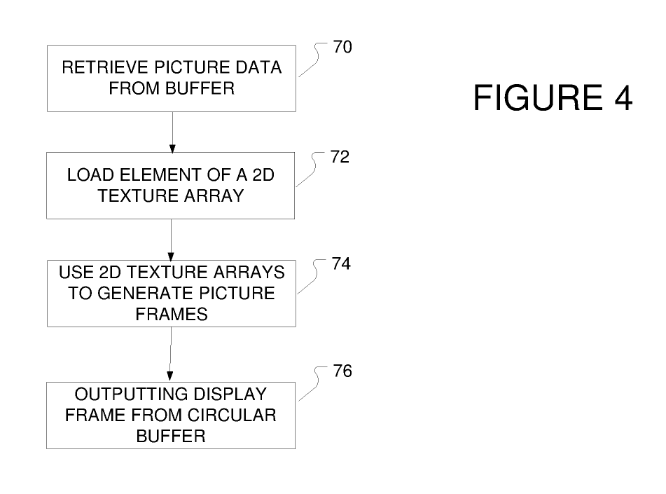

FIG. 4 shows an embodiment of a method of using 2D texture arrays to process video frames. The picture data is retrieved from the buffer at 70. The CPU loads elements of the 2D texture array with the picture data. Each element may be a processing element in the GPU, a partition of the GPU processor, etc. The 2D texture array is setup as a circular buffer. The GPU may use data from one or multiple texture entries in the circular buffer to generate the display frame. The rasterizer then outputs the computed display frame to the display device at 76.

The CPU processing block updates the individual elements of the 2D texture array in the GPU. The input video frame rate, scan type, progressive or interlaced, and the output display frame number determine whether an index in the array will be updated with new picture data. A GPU render loop typically runs at the output display scan rate, such as 60 Hz, while maintaining a frame number counter that represents the current frame number being displayed.

For example, the input video frame rate is 60p, which is 60 Hz progressive scan. In this case every picture frame, such as sourced from the acquisition hardware over PCIe, is pushed into a first-in-first-out (FIFO) 50 buffer that may have a configurable size, on the CPU side. For every iteration of the GPU render loop, the CPU processing block, mentioned above, pops a frame from the software FIFO and pushes it into a successive index of the 2D texture array 60, which is setup as a circular buffer, and returns an index into the circular buffer for use by the GPU shader code. A GPU shader 62, also referred to as a fragment shader, performs frame rate conversion to convert to the appropriate output frame rate.

The index into the circular buffer is passed into the GPU 16. Inside the GPU, fragment shader code, which may be a GPU processing block that processes pixel colors, samples the data at the above index and passes it to the GPU's rasterizer 64. The GPU then outputs this to the display monitor 66. If the GPU does not provide a fragment shader, one may be able to use a frame interlacer outside the GPU, which accomplishes a similar result.

In another example, the input video frame rate is 30p, meaning 30 HZ progressive scan. Every picture frame sourced from the acquisition hardware is pushed into a software FIFO having configurable size, on the CPU side. For every iteration of the GPU render loop, the CPU processing block mentioned above, checks to see if the current display frame number is even or odd. If it is even, it pops a frame from the software FIFO and pushes it into a successive index of the 2D texture array, which is setup as a circular buffer, and returns an index into the circular buffer for use by the GPU shader code. If it is odd, it repeats the previously determined index. This is the primary mechanism by which it can be determined, on the CPU side, whether a frame, already present in the 2D texture array—circular buffer, will be repeated or not to achieve frame rate conversion.

The index into the circular buffer is passed into the GPU. Inside the GPU, the fragment shader samples the data at the above index, from the appropriate half of the picture representing the even or odd fields in the interlaced frame and passes it to the GPU's rasterizer.

By using the 2D texture array of the GPU in the above manner, such as implementing it as a circular buffer whose current index is determined by the software running on the CPU, frame rate conversions are put together in a straightforward manner. Similar steps can be followed to implement conversions for other frame rates like 60i, 50p etc.

Embodiments such as those described above may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects of the embodiments may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the embodiments, and such data structures are contemplated within the scope of computer executable instructions and computer-usable data described herein.

The previously described versions of the disclosed subject matter have many advantages that were either described or would be apparent to a person of ordinary skill. Even so, all these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular aspect or embodiment, that feature can also be used, to the extent possible, in the context of other aspects and embodiments.

Also, when reference is made in this application to a method having two or more defined steps or operations, the defined steps or operations can be carried out in any order or simultaneously, unless the context excludes those possibilities.

Although specific embodiments have been illustrated and described for purposes of illustration, it will be understood that various modifications may be made without departing from the spirit and scope of the claims.

What is claimed is:

1. A system for displaying information, comprising:
a central processing unit, the central processing unit receiving real-time image data consisting of at least one of waveform and picture data, and web input data and producing a first graphics layer of web data, a second graphics layer of graticule data, and a third graphics layer of real-time data;
a memory connected to the central processing unit to store the first, second and third graphics layers;
a graphics processor to retrieve the first, second and third graphics layers from the memory and to generate a display window; and
a display device to display the display window.

2. The system of claim 1, wherein the graphics processor comprises an array of texture processing elements.

3. The system of claim 1, wherein the central processing unit receives a frame data signal.

4. The system of claim 3, wherein the frame data signal consists of at least one of a frame rate, frame number and a scan type.

5. The system of claim 1, further comprising a web developer front end connected to the central processing unit.

6. The system of claim 1, wherein the graphics processing unit further comprises a fragment shader.

7. The system of claim 1, wherein the graphics processing unit further comprises a rasterizer.

8. A method of combining different types of display data, comprising:
receiving, at a central processing unit, web data and real-time image data consisting of at least one of waveform and picture data;
generating, by the central processing unit, a first graphics layer of web data from the web data, a second graphics layer of graticule data; and a third layer of real-time data;
storing the first, second, and third graphics layers in memory;
retrieving, with a graphics processing unit, the first, second and third graphics layers from memory; and
producing, with the graphics processing unit, a composite display window of the first, second and third graphics layers.

9. The method of claim 8, wherein receiving the web based user interface data comprises receiving user interface data from a web based user interface.

10. The method of claim 8, wherein receiving the real-time image data comprises receiving real-time image data from a piece of monitoring equipment.

11. The method of claim 8, wherein producing the composite display window includes performing frame rate conversion.

12. The method of claim 8, wherein producing the composite display window includes rasterizing the display window.

13. The method of claim 8, further comprising:
receiving the real-time data at the central processing unit;
receiving a frame data signal at the central processing unit;
loading an element of a two-dimensional texture array in the graphics processing unit with the graphics data;
making an index identifying the element available to the graphics processing unit; and
sampling, with the graphics processing unit, the element identifying by the index and passing it to a rasterizing.

14. The method of claim 13, wherein frame data signal identifies the real-time data as progressive scan data.

15. The method of claim 14, wherein sampling comprises sampling the data with the fragment shader.

16. The method of claim 13, wherein the frame data signal identifies the real-time data as interlaced scan data.

17. The method of claim 16, wherein making an index identifying the element available further comprises determining if the index is even or odd.

18. The method of claim 17, wherein the sampling repeats sampling of an element if the index is odd.

19. The method of claim 17, wherein the sampling samples the successive element if the index is even.
